(19) United States
(12) Patent Application Publication
(10) Pub. No.: US 2026/0146191 A1
(43) Pub. Date: May 28, 2026

(54) AZEOTROPES OF 3-CHLORO-3,3-DIFLUORO-1-PROPENE, 3,3,3-TRIFLUOROPROPENE, AND HYDROGEN FLUORIDE

(71) Applicant: THE CHEMOURS COMPANY FC, LLC, WILMINGTON, DE (US)

(72) Inventors: XUEHUI SUN, KENNETT SQUASRE, PA (US); MICHAEL A. BRADLEY, HOCKESSIN, DE (US); KARL ROBERT KRAUSE, KENNETT SQUARE, PA (US)

(73) Assignee: THE CHEMOURS COMPANY FC, LLC, WILMINGTON, DE (US)

(21) Appl. No.: 19/121,615

(22) PCT Filed: Nov. 14, 2023
(86) PCT No.: PCT/US2023/037240

§ 371 Date: Apr. 16, 2025

Related U.S. Application Data
(60) Provisional application No. 63/426,604, filed on Nov. 18, 2022.

(51) Int. Cl. C09K 5/04

(52) U.S. Cl. CPC C09K 5/04

(57) ABSTRACT

Disclosed herein are azeotropic or near-azeotropic compositions including HCFO-1242zf, HFO-1243zf, and HF.

### CROSS REFERENCE TO RELATED APPLICATIONS

This application claims priority to U.S. Provisional Application No. 63/426,604, filed on Nov. 18, 2022, the disclosure of which is herein incorporated by reference in its entirety.

### FIELD

### Field of the Disclosure

This disclosure relates to processes for separating mixtures of hydrogen fluoride (HF), chlorofluoroolefin (HCFO) and fluoroolefin (HFO), and compositions therefrom. More specifically, this disclosure relates to mixtures including 3-chloro-3,3-difluoro-1-propene (HCFO-1242zf; CCIF₂CH═CH₂), 3,3,3-trifluoropropene (HFO-1243zf; CF₃CH═CH₂) and HF, and processes for separating such mixtures.

### Background

The refrigeration industry has been working for the past few decades to find replacement refrigerants for the ozone-depleting chlorofluorocarbons (CFCs) and hydrochlorofluorocarbons (HCFCs) being phased out as a result of the Montreal Protocol. The solution for most refrigerant producers has been the commercialization of hydrofluorocarbon (HFC) refrigerants. These new HFC refrigerants, HFC-134a being the most widely used at this time, have zero ozone depletion potentials and thus are not affected by the current regulatory phase-out as a result of the Montreal Protocol.

In addition to ozone depleting concerns, global warming is another environmental concern. However, many HFC replacement refrigerants tend to have a high global warming potential (GWP). For example, the GWP for HFC-134a is 1430. Thus, there remains a need for heat transfer compositions that meet both low ozone depletion and low global warming potentials. Certain hydrofluoroolefins (HFOs) meet both goals. Thus, there is a need for manufacturing processes that provide halogenated hydrocarbons and fluoroolefins that contain no chlorine and also have a lower global warming potential.

The chemical manufacture of fluoroolefins is typically a multi-step process that may produce intermediate mixtures of HFCs, HCFCs, hydrochlorofluoroolefins (HCFOs), and/or HFOs and hydrogen fluoride (HF). The separation of such mixtures is not always easily accomplished. Existing methods of distillation and decantation are very often ineffective for separation of these compounds.

Aqueous scrubbing may be effective but requires the use of large amounts of scrubbing solutions, additional equipment, and produces excessive waste as well as wet product that must then be dried. Therefore, there is a need for new methods of separating HF and fluoroolefins, hydrofluoroolefins, hydrochlorofluoroolefins, hydrochlorofluorocarbons, and/or hydrofluorocarbons.

### SUMMARY

In some embodiments, the inventions disclosed herein relate to a process for separating the components of a process stream comprising 3-chloro-3,3-difluoro-1-propene (HCFO-1242zf), 3,3,3-trifluoropropene (HFO-1243zf), and HF and forming an HF-rich stream comprising an azeotrope or near-azeotrope of HCFO-1242zf and HF.

In some embodiments, the invention disclosed herein relates to a process for distilling a process stream comprising 3-chloro-3,3-difluoro-1-propene (HCFO-1242zf), 3,3,3-trifluoropropene (HFO-1243zf) and a molar excess of HF based on the 3-chloro-3,3-difluoro-1-propene (HCFO-1242zf) and 3,3,3-trifluoropropene (HFO-1243zf) content of the stream into a bottoms stream comprising HF substantially free of 3-chloro-3,3-difluoro-1-propene (HCFO-1242zf) and 3,3,3-trifluoropropene (HFO-1243zf) and a distillate stream comprising 3-chloro-3,3-difluoro-1-propene (HCFO-1242zf), 3,3,3-trifluoropropene (HFO-1243zf) and HF.

In some embodiments, the invention disclosed herein relates to a process for forming multiple azeotropes comprising condensing a distillate stream of 3,3,3-trifluoropropene (HFO-1243zf) and chloro-3,3-difluoro-1-propene (HCFO-1242zf) containing a molar excess of HF which forms an HFO-1243zf/HF azeotrope or near-azeotrope and an HCFO-1242zf/HF azeotrope or near azeotrope.

In some embodiments, the invention disclosed herein relates to a process for forming a mixture of azeotropes or near-azeotropes comprising HCFO-1242zf/HF and HCFO-1243zf/HF.

In some embodiments, disclosed herein is a process for decanting a first stream comprising a mixture of azeotropes or near-azeotropes, a first HCFO-1242zf/HF azeotrope or near-azeotrope and a second HCFO-1243zf/HF azeotrope or near-azeotrope.

In some embodiments, disclosed herein is a process for forming an HF-rich azeotrope or near-azeotrope and an HF-poor azeotrope or near-azeotrope, wherein the HF-rich azeotrope or near-azeotrope comprises HFO-1242zf/HF and the HF-poor azeotrope or near-azeotrope comprises HCFO-1243zf/HF.

In some embodiments, disclosed herein is a process for distilling a stream comprising 3-chloro-3,3-difluoro-1-propene (HCFO-1242zf), 3,3,3-trifluoropropene (HFO-1243zf), and a molar excess of HF sufficient to form a mixture of heterogenous azeotropes or near-azeotropes and forming a distillate stream of heterogenous azeotropes or near-azeotropes.

In some embodiments, disclosed herein is a process for forming and using an HCFO-1242zf/HF azeotrope.

In some embodiments, disclosed herein is a process for contacting a feed or product stream with an HCFO-1242zf/HF azeotrope or near-azeotrope to remove HCFO-1242zf.

In some embodiments, disclosed herein are compositions including an HCFO-1242zf azeotrope or near-azeotrope with HF.

In some embodiments, disclosed herein are compositions comprising heterogenous HF containing azeotropes or near-azeotropes.

In some embodiments, disclosed herein are mixtures of HFO-1243zf/HF and HCFO-1242zf/HF azeotropes and near azeotropes.

Process embodiments disclosed herein use one or more distillation columns, condensers and decanters to form, produce and or use an HCFO-1242zf/HF azeotrope or near-azeotrope.

In one embodiment of the invention, an HFO-1243zf, HCFO-1242zf and HF stream containing sufficient HF (i.e., a molar excess which is sufficient to form a mixture of different azeotropes or near-azeotropes each containing HF) is conveyed to and through a distillation column under conditions to form a first distillate stream comprising HFO-1242zf and HFO-1243zf azeotropes or near azeotropes with HF.

In another embodiment of the invention, an HFO-1243zf, HCFO-1242zf and HF stream containing sufficient HF (i.e., a molar excess sufficient to form a mixture of HFO-1242zf/HF and HFO-1243zf/HF azeotropes or near-azeotropes) is conveyed to and through a distillation column under conditions to form a first distillate stream comprising HFO-1242zf and HFO-1243zf and azeotropes or near azeotropes with HF upon changing phases from a vapor to a liquid.

In one embodiment of the invention, an HFO-1243zf, HCFO-1242zf and HF stream containing sufficient HF (i.e., a molar excess sufficient to form a mixture of HFO-1242zf/HF and HFO-1243zf/HF azeotropes or near-azeotropes) is conveyed to and through a distillation column under conditions to form a first distillate stream comprising HFO-1242zf and HFO-1243zf and azeotropes or near azeotropes with HF, and a first bottoms stream of HF essentially free of the HCFO-1242zf and HFO-1243zf present in the distillation column.

In one embodiment, a mixture of HFO-1242zf/HF and HFO-1243zf/HF azeotropes or near-azeotropes is formed.

Another embodiment disclosed herein is directed to a process comprising distilling a process stream of HFO-1242zf, HFO-1243zf and HF, recovering a first distillate stream and a first bottom stream consisting essentially of HF free of HFO-1243zf and HFO-1242zf, condensing and transforming the first distillate stream to HF-rich and HF-poor liquid streams, respectively comprising HFO-1242zf and HF and HFO-1243zf and HF.

In another process embodiment, the present disclosure provides a process for separating 3-chloro-3,3-difluoro-1-propene (HCFO-1242zf) from an HCFO-1242zf-rich stream comprising HCFO-1242zf and HF involving distillation, condensation and/or cooling and decantation, where the HCFO-1242zf-rich stream from the decantation is distilled in a second distillation column under such boiling conditions that the HFO-1243zf and HCFO-1242zf azeotropes or near-azeotropes with HF are removed overhead as a second distillate stream, and HCFO-1242zf and HFO-1243zf are removed from the bottom of the second distillation column as a second bottoms stream essentially free of HF.

The process further comprises subjecting the second bottoms stream to a third distillation column to form an HCFO-1242zf stream essentially free of HFO-1243zf.

In another embodiment of the invention, the present disclosure provides an azeotrope or near-azeotrope composition comprising 3-chloro-3,3-difluoro-1-propene (HCFO-1242zf) and 3,3,3-trifluoropropene (HFO-1243zf) azeotropes or near-azeotropes with HF.

In a still further process embodiment, the present disclosure provides a process for separating 3-chloro-3,3-difluoro-1-propene (HCFO-1242zf) from a process stream comprising HCFO-1242zf, 3,3,3-trifluoropropene (HFO-1243zf)/HF and a molar excess of HF (i.e., a sufficient amount of HF to form azeotropes or near azeotropes). The process comprises subjecting the process stream to distillation in a first distillation column under the boiling conditions sufficient to remove excess HF as a bottoms stream yet leave enough HF in the distillate stream to permit formation of both an HFO-1243zf/HF azeotrope or near-azeotrope and an HFO-1242zf/HF azeotrope or near-azeotrope. The process also comprises forming a first distillate stream comprising an azeotropic or near-azeotropic composition of HCFO-1242zf, HFO-1243zf, and HF and a first bottoms stream of HF essentially free of HCFO-1242zf and HFO-1243zf from the first distillation column.

In another process embodiment the HCFO-1242zf, HFO-1243zf, and HF distillate is condensed and cooled, and then decanted to form an HCFO-1242zf rich (HF-poor) stream and an HF-rich stream (HCFO-1242zf-poor) stream. The process further comprises subjecting the HCFO-1242zf-rich stream to distillation in a second distillation column under boiling conditions to form HCFO-1242zf and HFO-1243zf azeotropes with HF. The process further comprises forming a second distillate stream comprising an azeotropic or near-azeotropic composition of HCFO-1242zf, HFO-1243zf, and HF and a second bottoms stream of HCFO-1242zf and HFO-1243zf essentially free of HF from the second distillation column. The process also comprises subjecting the second bottoms stream to a third standard distillation column to form an HCFO-1242zf stream essentially free of HFO-1243zf using methods known in the art.

In another embodiment of the invention, a heterogeneous HF-azeotrope mixture is described.

### Further Embodiments Disclosed Herein are as Follows:

Embodiment 1. An azeotropic or near-azeotropic composition comprising 3-chloro-3,3-difluoro-1-propene (HCFO-1242zf) and hydrogen fluoride (HF).

Embodiment 2. The azeotropic or near-azeotropic composition of Embodiment 1, wherein said azeotropic or near-azeotropic composition comprises about 9.8 to about 70.6 mole percent HCFO-1242zf and from about 90.2 to about 29.4 mole percent HF.

Embodiment 3. The azeotropic or near-azeotropic composition of any of the Embodiments disclosed herein, wherein the azeotropic or near-azeotropic composition has a vapor pressure of from about 6.5 psia (44.8 kPa) to about 29.8 psia (205.5 kPa) at a temperature of from about −10° C. to about 30° C.

Embodiment 4. The azeotropic or near-azeotropic composition of any of the Embodiments disclosed herein, wherein said azeotropic or near-azeotropic composition comprises about 38.0 mol % HCFO-1242zf and about 62.0 mol % HF.

Embodiment 5. The azeotropic or near-azeotropic composition of any of the Embodiments disclosed herein, wherein the azeotropic or near-azeotropic composition has a vapor pressure of about 25.9 psia at a temperature of about 20° C.

Embodiment 6. The azeotropic or near-azeotropic composition of any of the Embodiments disclosed herein, wherein the azeotropic or near-azeotropic composition is prepared by weighing desired amounts of HCFO-1242zf and HF and thereafter combining them in an appropriate container.

Embodiment 7. The azeotropic or near-azeotropic composition of any of the Embodiments disclosed herein, wherein the azeotropic or near-azeotropic composition consists essentially of HCFO-1242zf and HF.

Embodiment 8. A composition comprising the azeotropic or near-azeotropic composition of any of the Embodiments disclosed herein and 3,3,3-trifluoropropene (HFO-1243zf).

Embodiment 9. A composition comprising the azeotropic or near-azeotropic composition of any of the Embodiments disclosed herein and 1,1,1,3-tetrafluoropropane (HFC-254fb).

Embodiment 10. The composition of any of the Embodiments disclosed herein, wherein the composition further comprises one or more additional components selected from the group consisting of 3-chloro-3,3,-difluoropropene (HCFO-1242zf; CF₂Cl—CH═CH₂), dichlorodifluoromethane (CFC-12; CCl₂F₂), chlorotrifluoromethane (CFC-13; CCIF₃), 1,1,1-trifluoroethane (HFC-143a; CF₃—CH₃), 2-chloro-1,1,1-trifluoropropane (HCFC-253 db; CF₃—CHCl—CH₃), 3-chloro-1,1,1-trifluoropropane (HCFC-253fb; CF₃—CH₂—CH₂Cl), 1,1,1,2-tetrafluoropropane (HFC-254eb; CF₃—CHF—CH₃), 1,1,1-trifluoropropane (HFC-263fb; CF₃CH₂CH₃), 2-chloro-3,3,3-trifluoropropene (HCFO-1233xf; CF₃—CCl═CH₂), 1-chloro-3,3,3-trifluoropropene (HCFO-1233zd; CF₃—CH₂═CHCl), isomers of trichloropropene (HCO-1240; C₃H₃Cl₃), and combinations thereof.

Embodiment 11. An azeotropic or near-azeotropic composition comprising 3-chloro-3,3-difluoro-1-propene (HCFO-1242zf), 3,3,3-trifluoropropene (HFO-1243zf), and hydrogen fluoride (HF).

Embodiment 12. A composition comprising a mixture of an azeotrope or near-azeotrope comprising 3-chloro-3,3-difluoro-1-propene (HCFO-1242zf) and hydrogen fluoride (HF) and an azeotrope or near-azeotrope comprising 3,3,3-trifluoropropene (HFO-1243zf) and HF.

Embodiment 13. The composition of any of the Embodiments disclosed herein, wherein the HCFO-1242zf and HF portion of the azeotropic or near azeotropic composition comprises about 9.8 to about 70.6 mole percent HCFO-1242zf and about 90.2 to about 29.4 mole percent HF.

Embodiment 14. The composition of any of the Embodiments disclosed herein, wherein the HCFO-1242zf and HF portion of the azeotropic or near azeotropic composition has a vapor pressure of from about 6.5 psia (44.8 kPa) to about 29.8 psia (205.5 kPa) at a temperature of from about −10° C. to about 30° C.

Embodiment 15. The composition of any of the Embodiments disclosed herein, wherein the HCFO-1242zf and HF portion of the azeotropic or near azeotropic composition comprises about 38.0 mol % HCFO-1242zf and about 62.0 mol % HF.

Embodiment 16. The composition of any of the Embodiments disclosed herein, wherein the HCFO-1242zf and HF portion of the azeotropic or near azeotropic composition has a vapor pressure of about 25.9 psia at a temperature of about 20° C.

Embodiment 17. The composition of any of the Embodiments disclosed herein, further comprising 1,1,1,3-tetrafluoropropane (HFC-254fb).

The foregoing general description and the following detailed description are exemplary and explanatory only and are not restrictive of the invention, as defined in the appended claims.

Other features and benefits of any one or more of the embodiments described herein will be apparent from the following detailed description, appended drawings and from the claims.

### BRIEF DESCRIPTION OF THE DRAWINGS

Embodiments are illustrated in the accompanying figure to improve understanding of concepts as presented herein.

FIG. 1 is an illustration of an embodiment of an azeotropic distillation for the separation of HCFO-1242zf from a mixture containing HCFO-1242zf, HFO-1243zf, and HF.

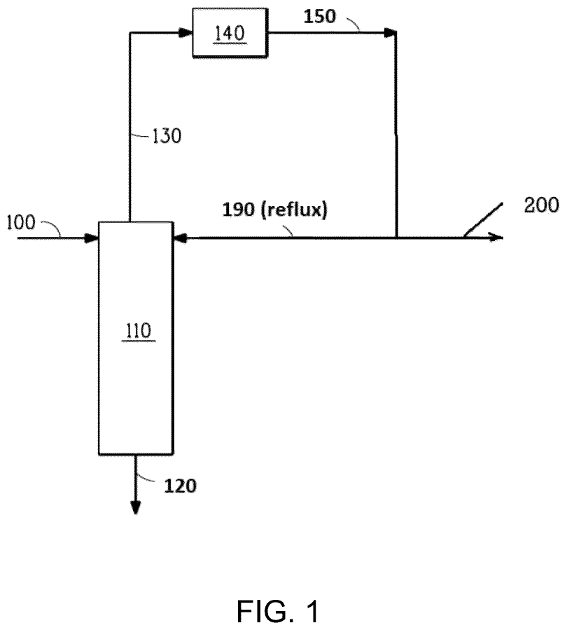

FIG. 2 illustrates another embodiment of an azeotrope distillation for the separation of HCFO-1242zf from a mixture containing HCFO-1242zf, HFO-1243zf, and HF.

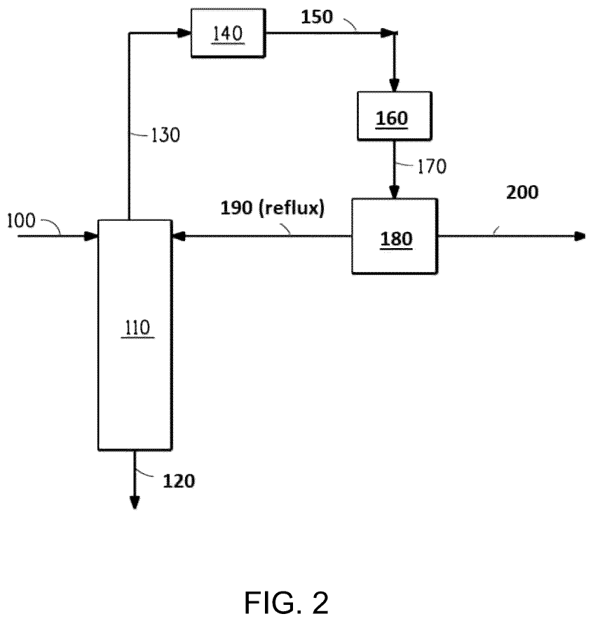

FIG. 3 illustrates a still further an embodiment of an azeotrope distillation for the separation of HCFO-1242zf from a mixture containing HCFO-1242zf, HFO-1243zf, and HF.

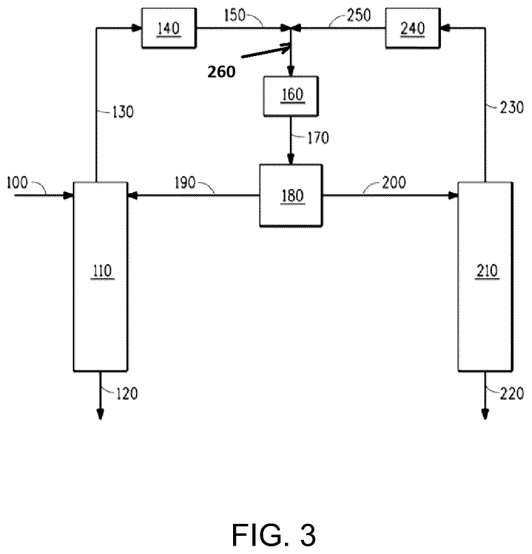

Skilled artisans appreciate that objects in the figures are illustrated for simplicity and clarity and have not necessarily been drawn to scale. For example, the dimensions of some of the objects in the figures may be exaggerated relative to other objects to help to improve understanding of embodiments.

### DETAILED DESCRIPTION OF THE INVENTION

High purity 3,3,3-trifluoropropene (HFO-1243zf) is desired for subsequent downstream conversion to hydrofluorocarbons, hydrochlorofluorocarbons fluoroolefins and hydrochlorofluoroolefins including, but not limited to HFO-1234ze and HFO-1234yf, or as a refrigerant or refrigerant component. Vapor phase reaction of 1,1,1,3-tetrachloropropane (HCC-250fb) and HF in the absence or presence of a catalyst, at HF: 250fb concentrations in molar excess will result in high yields of HFO-1243zf and other products having a lower degree of fluorination, such as HCFO-1242zf, as disclosed in U.S. patent No. U.S. Pat. No. 6,329,559, the disclosure of which is incorporated herein by reference in its entirety. Multi-step processes for producing HFO-1234yf from HFO-1243zf also include using HCFC-250fb as a starting material for producing HFO-1243zf by fluorination as disclosed in U.S. Pat. No. 8,318,992, the disclosure of which is incorporated herein by reference in its entirety. The molar ratio of HF:250fb which is used to produce HFO-1243zf is between 3:1 and at least about 50:1.

It has been observed that low-boiling azeotropes or near-azeotropes of HFO-1243zf are formed from a product stream comprising HFO-1243zf and HF, as disclosed in International Application WO2009105517, the disclosure of which is incorporated herein by reference in its entirety. The data of Table 1 therein illustrates that the molar ratio of HF/1243zf in the azeotrope is about 1:3.

It has been surprisingly found that HCFO-1242zf forms low boiling azeotropes or near azeotropes with HF, and they can be used to produce HF essentially free of HCFO-1242zf and HFO-1243zf in a single distillation, even though HCFO-1242zf has a very similar boiling point to HF (only 1° C. different at atmospheric pressure).

It was therefore unexpected that an HCFO-1242zf/HF azeotrope or near-azeotrope, which is HF-rich and contains about 62.0 mole percent HF at a vapor pressure of 25.9 psia and at a temperature of 20° C., would form.

Before addressing details of embodiments described below, some terms are defined or clarified.

By “azeotropic” composition is meant a constant boiling liquid admixture of two or more substances that behaves as a single substance. In general, azeotropy is the phenomenon where a composition comprising two or more molecular species such that the relative volatility between any binary pair of components is unity. That is, the composition of a boiling liquid mixture exhibiting azeotropy is identical to the vapor phase that is produced.

$${α}_{i j} = \frac{{K}_{i}}{{K}_{j}} = \frac{{y}_{i} / {x}_{i}}{{y}_{j} / {x}_{j}} = 1 ∀ \{ i , j \} ,$$

where: αᵢⱼ is the relative volatility between component i and component j, Ki is the K factor for component i, Kj is the K factor for component j, yi and xi are the vapor and liquid molar fractions of component i, yj and xj are the vapor and liquid molar fractions of component j.

Additionally, the temperature of a boiling mixture exhibiting azeotropy is constant at a constant pressure. A system is azeotropic when it can be distilled (or condensed) without change of composition. The notion of a system that is “azeotrope-like” or exhibiting “near azeotropy” is commonly known as a system close enough to azeotropy such that the compositions of the liquid and vapor phases in phase equilibrium are of very similar compositions such that during a boiling process the boiling temperature only rises to a small degree. Therefore, all relative volatilities for all i-j binary pairs of the system in the above equation will be very close to unity. Thus, one way to characterize an azeotropic composition is that the vapor produced by partial evaporation or distillation of the liquid has the same composition as the liquid from which it was evaporated or distilled, that is, the admixture distills/refluxes without compositional change. Constant boiling compositions are characterized as azeotropic because they exhibit either a maximum or minimum boiling point, as compared with that of the non-azeotropic mixtures of the same components. Azeotropic compositions are also characterized by a minimum or a maximum in the vapor pressure of the mixture relative to the vapor pressure of the neat components at a constant temperature.

By “azeotrope-like” composition (sometimes referred to as “near-azeotrope”) is meant a constant boiling, or substantially constant boiling, liquid admixture of two or more substances that behaves as a single substance. Another way to characterize an azeotrope-like or near-azeotrope composition is that the bubble point vapor pressure and the dew point vapor pressure of the composition at a particular temperature are substantially the same. An azeotrope-like or near-azeotrope composition can also be characterized by the area that is adjacent to the maximum or minimum vapor pressure in a plot of composition vapor pressure at a given temperature as a function of mole fraction of components in the composition.

As disclosed herein the terms “azeotrope-like composition” and “near-azeotrope composition” shall be understood to mean a composition wherein the difference between the bubble point pressure (“BP”) and dew point pressure (“DP”) of the composition at a particular temperature is less than or equal to 5 percent based upon the bubble point pressure, i.e., [(BP-DP)/BP]×100≤5, and more preferably a composition wherein the difference between the bubble point pressure (“BP”) and dew point pressure (“DP”) of the composition at a particular temperature is less than or equal to 3 percent based upon the bubble point pressure, i.e., [(BP-DP)/BP]×100 is 3.

For compositions that are azeotropic, there is usually some range of compositions around the azeotrope point that, for a maximum boiling azeotrope, have boiling points at a particular pressure higher than the pure components of the composition at that pressure and have vapor pressures at a particular temperature lower than the pure components of the composition at that temperature, and that, for a minimum boiling azeotrope, have boiling points at a particular pressure lower than the pure components of the composition at that pressure and have vapor pressures at a particular temperature higher than the pure components of the composition at that temperature. Boiling temperatures and vapor pressures above or below that of the pure components are caused by unexpected intermolecular forces between and among the molecules of the compositions, which can be a combination of repulsive and attractive forces such as van der Waals forces and hydrogen bonding.

It is recognized in the art that both the boiling point and the amount of each component of an azeotropic composition can change when the azeotrope liquid composition is subjected to boiling at different pressures. Thus, an azeotropic composition may be defined in terms of the unique relationship that exists among components or in terms of the exact amounts of each component of the composition characterized by a fixed boiling point at a specific pressure. An azeotrope or azeotrope-like composition of two or more compounds can be characterized by defining compositions characterized by a boiling point at a given pressure, thus providing identifying characteristics without unduly limiting the scope of the invention by a specific numerical composition, which is limited by and is only as accurate as the analytical equipment available.

It is also recognized in this field that when the relative volatility of a system approaches 1.0, the system is defined as forming an azeotrope-like or near-azeotrope composition. Relative volatility is the ratio of the volatility of a first component to the volatility of a second component. The ratio of the mole fraction of a component in vapor to that in liquid is the volatility of the component.

To determine the relative volatility of any two compounds, a method known as the PTx method can be used. In this procedure, the total absolute pressure in a cell of known volume is measured at a constant temperature for various compositions of the two compounds. Use of the PTx Method is described in detail in “Phase Equilibrium in Process Design”, Wiley-Interscience Publisher, 1970, written by Harold R. Null, on pages 124 to 126, hereby incorporated by reference.

These measurements can be converted into equilibrium vapor and liquid compositions in the PTx cell by using an activity coefficient equation model, such as the Non-Random, Two-Liquid (NRTL) equation, to represent liquid phase nonidealities. Use of an activity coefficient equation, such as the NRTL equation is described in detail in “The Properties of Gases and Liquids,” 4th edition, published by McGraw Hill, written by Reid, Prausnitz and Poling, on pages 241 to 387, and in “Phase Equilibria in Chemical Engineering,” published by Butterworth Publishers, 1985, written by Stanley M. Walas, pages 165 to 244. Both aforementioned references are hereby incorporated by reference. Without wishing to be bound by any theory or explanation, it is believed that the NRTL equation, together with the PTx cell data, can sufficiently predict the relative volatilities of the HFO-1243zf-containing and HCFO-1242zf-containing compositions of the present disclosure at conditions other than those where measurements were made and can therefore predict the behavior of these mixtures in multi-stage separation equipment such as distillation columns. See for example, U.S. Pat. No. 8,486,293 and International Publication No. WO2009105517, the disclosure of each being incorporated herein by reference which rely on PTx data to predict mixtures, e.g., 254eb and 1234zf with HF.

The conditions and compositions for HF/HCFO-1242zf azeotropes, according to the present invention, calculated as described above are provided in Table A below.

TABLE A
HF/HFCO-1242zf

| Temperature, | Pressure, | Mole % | Mole % |
|---|---|---|---|
| ° C. | psia | HF | HFCO-1242zf |
| −10 | 6.5 | 90.2 | 9.8 |
| −5 | 9.1 | 86.0 | 14.0 |
| 0 | 12.4 | 82.3 | 17.7 |
| 5 | 16.1 | 79.3 | 20.7 |
| 10 | 19.9 | 76.3 | 23.7 |
| 15 | 23.4 | 71.9 | 28.1 |
| 20 | 25.9 | 62.0 | 38.0 |
| 25 | 27.8 | 45.3 | 54.7 |
| 30 | 29.8 | 29.4 | 70.6 |

Based upon these findings, the present invention provides an azeotropic or near-azeotropic composition comprising, consisting of or consisting essentially of about 9.8 to about 70.6 mole percent HCFO-1242zf and from about 90.2 to about 29.4 mole percent HF.

In some embodiments, the present invention provides an azeotropic or near-azeotropic composition comprising, consisting of or consisting essentially of about 9.8 to about 70.6 mole percent HCFO-1242zf and from about 90.2 to about 29.4 mole percent HF, and having a boiling point of from about 30° C. at about 29.8 psia (205.5 kPa) to about −10° C. at about 6.5 psia (44.8 kPa).

As used herein, the term “azeotrope” is meant to refer to azeotrope compositions, azeotrope-like compositions, azeotrope composition and/or near-azeotrope composition.

The process equipment for all the processes disclosed herein and the associated feed lines, effluent lines and associated units may be constructed of materials resistant to hydrogen fluoride. Typical materials of construction, well-known to the art, include stainless steels, in particular of the austenitic type, and the well-known high nickel alloys such as Monel® nickel-copper alloys, Hastelloy® nickel-based alloys and Inconel® nickel-chromium alloys.

By azeotropic distillation is meant a process in which a distillation column is operated under conditions to cause one or more azeotropic or azeotrope-like compositions to form, and thereby facilitates the separation of the components of the mixture. Azeotropic distillations may occur where only the components of the mixture to be separated are distilled, or where an entrainer is added that forms an azeotrope with one or more of the components of the initial mixture. Entrainers that act in this manner, that is to say, that form an azeotrope with one of more of the components of the mixture to be separated thus facilitating the separation of those components by distillation, are more commonly called azeotroping agents or azeotropic entrainers.

In conventional or azeotropic distillations, the overhead or distillate stream exiting the column may be condensed using conventional reflux condensers. At least a portion of this condensed stream can be returned to the top of the column as reflux, and the remainder recovered as product or for optional processing. The ratio of the condensed material which is returned to the top of the column as reflux to the material removed as distillate is commonly referred to as the reflux ratio. The compounds and entrainer exiting the column as distillate or distillation bottoms stream can then be passed to a stripper or second distillation column for separation by using conventional distillation, or may be separated by other methods, such as decantation. If desired, the entrainer may then be recycled back to the first distillation column for reuse. In some embodiments, the composition and the separation process are free of or essentially free of an added entrainer.

The specific conditions which can be used for practicing the invention depend upon a number of parameters, such as the diameter of the distillation column, feed points, number of separation stages in the column, among others. In some embodiments, the operating pressure of the distillation system may range from about 5 to about 500 psia (34 to 3450 kPa), in another embodiment, about 20 to about 400 psia (140 to 2760 kPa). Normally, increasing the reflux ratio results in increased distillate stream purity, but generally the reflux ratio ranges between about 1/1 to about 200/1. The temperature of the condenser, which is located adjacent to the top of the column, is normally sufficient to substantially fully condense the distillate that is exiting from the top of the column or is the temperature required to achieve the desired reflux ratio by partial condensation.

As used herein, by “essentially free of” is meant that a composition contains less than about 100 ppm (mole basis), less than about 10 ppm or less than about 1 ppm, of the specified component. If a composition is essentially free of more than one component, then the total concentration of those components is less than about 100 ppm, less than about 10 ppm, or less than about 1 ppm.

Hydrogen fluoride (HF, anhydrous) is a commercially available chemical or can be produced by methods known in the art.

“Molar excess of HF” means an amount of HF in excess of that necessary to form an azeotrope or a near azeotrope mixture with the organic (HFC or HFO) present in a composition. The molar amount of HF will vary as a function of the organic present in the composition to be separated as well as separation conditions. The molar excess of HF for a given composition is an amount of HF greater than the amount of HF which is required to form an azeotrope (or near azeotrope mixture) for each organic compound in the composition.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The transitional phrase “consisting of” excludes any element, step, or ingredient not specified. If in the claim such would close the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” is used to define a composition, method that includes materials, steps, features, components, or elements, in addition to those literally disclosed provided that these additional included materials, steps, features, components, or elements do not materially affect the basic and novel characteristic(s) of the claimed invention, especially the mode of action to achieve the desired result of any of the processes of the present invention. The term “consisting essentially of” occupies a middle ground between “comprising” and “consisting of.”

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present disclosure, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

Described herein are processes for separating HCFO-1242zf, HFO-1243zf, and HF from a composition comprising HCFO-1242zf, HFO-1243zf, and HF. The processes comprising subjecting the composition to a first distillation step, forming a column (first) distillate composition capable of forming azeotrope or near-azeotrope compositions of HCFO-1242zf/HF and HFO-1243zf/HF, and a bottoms HF stream composition which is essentially free of HCFO-1242zf and HFO-1243zf. By essentially free in this context is meant less than about 1000 ppm, less than about 500 ppm, less than about 100 ppm, or less than about 10 ppm.

Described herein are azeotropic and near-azeotrope compositions comprising 3-chloro-3,3-difluoro-1-propene (HCFO-1242zf) or 3,3,3-trifluoropropene (HFO-1243zf), each with hydrogen fluoride (HF).

Also described here are compositions comprising HCFO-1242zf, HFO-1243zf, and HF to be separated.

In some embodiments, the composition comprising HCFO-1242zf, HFO-1243zf, and HF is a process stream.

In some embodiments, the composition to be separated contains additional HCFO-1242zf or HF, beyond the amount necessary to form the azeotropic or azeotrope-like composition.

In some embodiments, the separation process is part of a general process to manufacture 3,3,3-trifluoropropene (HFO-1243zf, CF₃CH═CH₂). In some embodiments, the manufacture of HFO-1243zf is part of a general process to manufacture of 2,3,3,3-tetrafluoropropene (HFO-1234yf; CF₃CF═CH₂). In some embodiments, the separation process separates a process stream that is a reaction product stream of a reaction process to produce HFO-1243zf. In some embodiments, the reaction process produces HFO-1243zf by fluorination of 1,1,1,3-tetrachloropropane (HCC-250fb; CCl₃CH₂CH₂Cl).

HFO-1243zf may be made by fluorination of HCC-250fb with HF over a fluorination catalyst such as chromium/alumina fluoride or chromium oxide catalysts. HCC-250fb may be made by processes known in the art such as described in US U.S. Pat. Nos. 4,605,802 and 5,705,779, the disclosure of each of which is hereby incorporated by reference in its entirety, by an addition reaction of carbon tetrachloride and ethylene.

The reaction product stream by fluorination of HCC-250fb with HF may include HCFO-1242zf and other intermediate products in addition to excess HF and the HFO-1243zf product. Other intermediate products may include one or more of 3-chloro-3,3,-difluoropropene (HCFO-1242zf; CF₂Cl—CH═CH₂), dichlorodifluoromethane (CFC-12; CCl₂F₂), chlorotrifluoromethane (CFC-13; CCIF₃), 1,1,1-trifluoroethane (HFC-143a; CF₃—CH₃), 2-chloro-1,1,1-trifluoropropane (HCFC-253 db; CF₃—CHCl—CH₃), 3-chloro-1,1,1-trifluoropropane (HCFC-253fb; CF₃—CH₂—CH₂Cl), 1,1,1,2-tetrafluoropropane (HFC-254eb; CF₃—CHF—CH₃), 1,1,1-trifluoropropane (HFC-263fb; CF₃CH₂CH₃), 2-chloro-3,3,3-trifluoropropene (HCFO-1233xf; CF₃—CCl═CH₂), 1-chloro-3,3,3-trifluoropropene (HCFO-1233zd; CF₃—CH₂═CHCl), isomers of trichloropropene (HCO-1240; C₃H₃Cl₃), or combinations thereof.

HFO-1243zf has been found to form a binary azeotropic composition with HF, as disclosed in International Application Publication No. WO2009/105517, the disclosure of which is incorporated herein by reference in its entirety. The azeotropic composition comprises about 72.0 mole % HFO-1243zf and about 28.0 mole % HF at 29.8° C. and 106.6 psia (735 kPa). Further, the azeotropic composition comprises about 76.2 mole % HFO-1243zf and about 23.8 mole % HF at 79.7° C. and 363 psia (2503 kPa).

Surprisingly, it has been found that HCFO-1242zf also forms a binary azeotrope with HF.

For purposes of this disclosure, “effective amount” is defined as the amount of each component of the inventive compositions which, when combined, results in the formation of an azeotropic or azeotrope-like composition. This definition includes the amounts of each component, which amounts may vary depending on the pressure applied to the composition so long as the azeotropic or azeotrope-like compositions continue to exist at the different pressures, but with possible different boiling points. Therefore, effective amount includes the amounts, such as may be expressed in weight percentages, of each component of the compositions of the instant disclosure which form azeotropic or azeotrope-like compositions at temperatures or pressures other than as described herein.

For the purposes of this disclosure, azeotropic or constant-boiling is intended to mean also essentially azeotropic or essentially-constant boiling. In other words, included within the meaning of these terms are not only the true azeotropes described above, but also other compositions containing the same components in different proportions, which are true azeotropes at other temperatures and pressures, as well as those equivalent compositions which are part of the same azeotropic system and are azeotrope-like in their properties. As is well recognized in this art, there is a range of compositions which contain the same components as the azeotrope, which will not only exhibit essentially equivalent properties for refrigeration and other applications, but which will also exhibit essentially equivalent properties to the true azeotropic composition in terms of constant boiling characteristics or tendency not to segregate or fractionate on boiling.

It is possible to characterize, in effect, a constant boiling admixture which may appear under many guises, depending upon the conditions chosen, by any of several criteria: The composition can be defined as an azeotrope of A, B, C (and D . . . ) since the very term “azeotrope” is at once both definitive and limitative, and requires effective amounts of A, B, C (and D . . . ) for this unique composition of matter which is a constant boiling composition. It is well known by those skilled in the art, that, at different pressures, the composition of a given azeotrope will vary at least to some degree, and changes in pressure will also change, at least to some degree, the boiling point temperature. Thus, an azeotrope of A, B, C (and D) represents a unique type of relationship but with a variable composition which depends on temperature and/or pressure. Therefore, compositional ranges, rather than fixed compositions, are often used to define azeotropes. The composition can be defined as a particular weight percent relationship or mole percent relationship of A, B, C and D, while recognizing that such specific values point out only one particular relationship and that in actuality, a series of such relationships, represented by A, B, C (and D) actually exist for a given azeotrope, varied by the influence of pressure. An azeotrope of A, B, C (and D) can define the compositions as an azeotrope characterized by a boiling point at a given pressure, thus giving identifying characteristics without unduly limiting the scope of the invention by a specific numerical composition, which is limited by and is only as accurate as the analytical equipment available.

When there are two azeotropes, the composition can be defined as an azeotrope of A which is HFO-1243zf/HF and B which is HCFO-1242zf/HF, or vice versa, since the very term “azeotrope” is at once both definitive and limitative and requires that effective amounts of A and B for this unique composition of matter which is a constant boiling composition. It is well known by those skilled in the art, that, at different pressures, the composition of a given azeotrope will vary at least to some degree, and changes in pressure will also change, at least to some degree, the boiling point temperature. Thus, the azeotropes of A and B represent a unique type of relationship but with a variable composition which depends on temperature and/or pressure. Therefore, compositional ranges, rather than fixed compositions, are often used to define azeotropes. The composition can be defined as a particular weight percent relationship or mole percent relationship of A and B, while recognizing that such specific values point out only one particular relationship and that in actuality, a series of such relationships, represented by A and B actually exist for a given azeotrope, varied by the influence of pressure. An azeotrope of A and B can be characterized by defining the compositions as an azeotrope characterized by a boiling point at a given pressure, thus giving identifying characteristics without unduly limiting the scope of the invention by a specific numerical composition, which is limited by and is only as accurate as the analytical equipment available.

The azeotrope or azeotrope-like compositions of the present disclosure can be prepared by any convenient method including mixing or combining the desired amounts. A preferred method is to weigh the desired component amounts and thereafter combine them in an appropriate container. Another preferred method is to for the azeotrope or azeotrope-like compositions as the distillate stream of a distillation column.

It has been discovered that some fluoroolefins form azeotrope compositions with HF. Generally, the fluoroolefin/HF azeotrope composition will boil at a lower temperature than the corresponding pure compounds. Several examples of such fluoroolefin/HF azeotropes are disclosed in, for example, International Application No. WO2009/105517 the disclosure of which is incorporated herein by reference in its entirety.

It was unexpected that HCFO-1242zf would form an azeotrope or azeotrope-like composition with HF, and it has been unexpectedly observed that, in a few cases, azeotrope compositions comprising fluoroolefins and HF may form two liquid phases when condensed and/or cooled. The two phases comprise a chlorofluoroolefin-rich phase and an HF-rich phase. This phase behavior allows unique separation schemes utilizing liquid-liquid separation (such as decantation) of the two phases that are not possible with many saturated hydrofluorocarbons, which in general do not phase-separate in the same manner.

In some embodiments, a process is provided for separating hydrogen fluoride (HF) from a composition (e.g., a process stream) comprising 3-chloro-3,3-difluoro-1-propene (HCFO-1242zf), 3,3,3-trifluoropropene (HFO-1243zf), and a molar excess of HF. The process comprises subjecting the process stream to distillation in a first distillation column under the boiling conditions of HCFO-1242zf/HF and HFO-1243zf/HF azeotrope, with a molar excess of HF to produce both azeotropes. The process also comprises forming a first distillate stream comprising an azeotropic or near-azeotropic composition of HCFO-1242zf/HF and HFO-1243zf/HF and a first bottoms stream of HF essentially free of HCFO-1242zf and HFO-1243zf from the first distillation column.

In some embodiments, the process of the above paragraph further comprises condensing, cooling, and decanting the first distillate stream to form an HF-enriched stream, e.g., HCFO-1242zf/HF rich stream.

In some embodiments, the process further comprises subjecting the HCFO-1242zf-HF rich stream to distillation in a second distillation column under the boiling conditions of an HCFO-1242zf/HF and HFO-1243zf/HF azeotrope, and forming a second distillate stream comprising an azeotropic or near-azeotropic composition of HCFO-1242zf/HF and HFO-1243zf/HF and a second bottoms stream of HCFO-1242zf and HFO-1243zf essentially free of HF from the second distillation column.

In some embodiments, the process further comprises subjecting the second bottoms stream to a third distillation column to form an HCFO-1242zf stream essentially free of HFO-1243zf.

In some embodiments, the process further comprises combining the first distillate stream with the second distillate stream prior to decanting.

In some embodiments, the process stream is a product stream from the fluorination reaction of 1,1,1,3-tetrachloropropane (HCC-250fb) with HF to produce HFO-1243zf.

In some embodiments, the process comprises subjecting a process stream, such as that provided by the fluorination of HCC-250fb, to distillation in a first distillation column under the boiling conditions for HCFO-1242zf- and HFO-1243zf-HF azeotrope. The process also comprises forming a first distillate stream comprising a molar excess of HF to provide for an azeotropic or near-azeotropic composition of both HCFO-1242zf and HF and HFO-1243zf and HF, and a first bottoms stream of HCFO-1242zf and HFO-1243zf essentially free of HF from the first distillation column. The process further comprises sequentially condensing and decanting the distillate, while the first bottoms stream is essentially pure HF, containing at most about 50 ppm HCFO-1242zf and trace amounts of HFO-1243zf, preferably less than about 1 ppm HCFO-1242zf.

In some embodiments, the HCFO-1242zf-rich stream is formed by decanting an azeotropic or near-azeotropic composition of HCFO-1242zf, HFO-1243zf, and HF.

In some embodiments, a process is provided for separating 3-chloro-3,3-difluoro-1-propene (HCFO-1242zf) from a process stream comprising HCFO-1242zf, 3,3,3-trifluoropropene (HFO-1243zf), and a molar excess of hydrogen fluoride (HF). The process comprises subjecting the HFO-1243zf process stream to distillation in a first distillation column under the boiling conditions of HCFO-1242zf, HFO-1243zf, and HF azeotropes. The process also comprises forming a first distillate stream comprising a composition of HCFO-1242zf/HF and HCFO-1243zf/HF azeotropes or near-azeotropes, and excess HF, and a first bottoms stream of HF essentially free of HCFO-1242zf and HFO-1243zf from the first distillation column. The process further comprises condensing, cooling, and decanting the first distillate stream to form an HF-enriched stream and an HCFO-1242zf-rich stream. The process further comprises subjecting the HCFO-1242zf-rich stream to distillation in a second distillation column under the boiling conditions of an HCFO-1242zf/HF and HFO-1243zf/HF azeotropes. The process further comprises forming a second distillate stream comprising an azeotropic or near-azeotropic composition of HCFO-1242zf/HF and HFO-1243zf/HF, and a second bottoms stream of HCFO-1242zf and HFO-1243zf essentially free of HF from the second distillation column. The process also comprises subjecting the second bottoms stream to a third distillation column, using standard distillation techniques, to form an HCFO-1242zf stream essentially free of HFO-1243zf.

In some embodiments, the process stream containing HFO-1242zf and HFO-1243zf is a reaction product stream of a reaction process to produce HFO-1243zf by fluorination of 1,1,1,3-tetrachloropropane (HCC-250fb) with HF, and optionally includes 1,1,1,3-tetrafluoropropane (HFC-254fb).

In some embodiments, the first and second distillate streams of any of the above paragraphs comprise an azeotropic or near-azeotropic composition comprising about 9.8 to about 70.6 mole percent HCFO-1242zf and from about 90.2 to about 29.4 mole percent HF.

In some embodiments, the first and second distillate streams of any of the above paragraphs comprise an azeotropic or near-azeotropic composition comprising about 9.8 to about 70.6 mole percent HCFO-1242zf and from about 90.2 to about 29.4 mole percent HF and having a vapor pressure of from about 6.5 psia to about 29.8 psia at a temperature of from about −10° C. to about 30° C.

In some embodiments, the first and distillate streams comprise about 38.0 mol % HCFO-1242zf and about 62.0 mol % HF and have a vapor pressure of about 25.9 psia at a temperature of about 20° C.

In some embodiments, an azeotropic or near-azeotropic composition comprising 3-chloro-3,3-difluoro-1-propene (HCFO-1242zf), 3,3,3-trifluoropropene (HFO-1243zf), and hydrogen fluoride (HF) is provided.

In some embodiments, an azeotropic or near-azeotropic composition comprising HCFO-1242zf and HF is provided.

In some embodiments, the azeotropic or near-azeotropic composition comprises about 9.8 to about 70.6 mole percent HCFO-1242zf and from about 90.2 to about 29.4 mole percent HF.

In some embodiments, the azeotropic or near-azeotropic composition comprises about 9.8 to about 70.6 mole percent HCFO-1242zf and from about 90.2 to about 29.4 mole percent HF and has a vapor pressure of from about 6.5 psia to about 29.8 psia at a temperature of from about −10° C. to about 30° C.

In some embodiments, the azeotropic or near-azeotropic composition comprises about 38.0 mol % HCFO-1242zf and about 62.0 mol % HF and has a vapor pressure of about 25.9 psia at a temperature of about 20° C.

In some embodiments, the composition of the azeotropic or near-azeotropic further comprises 1,1,1,3-tetrafluoropropane (HFC-254fb).

In some embodiments, the HCFO-1242zf and HF portion of an azeotropic or near azeotropic composition of HCFO-1242zf, HFO-1243zf, and HF includes about 9.8 to about 70.6 mole percent HCFO-1242zf and from about 90.2 to about 29.4 mole percent HF.

In some embodiments, the HCFO-1242zf and HF portion of an azeotropic or near azeotropic composition of HCFO-1242zf, HFO-1243zf, and HF includes about 9.8 to about 70.6 mole percent HCFO-1242zf and from about 90.2 to about 29.4 mole percent HF with a vapor pressure of from about 6.5 psia to about 29.8 psia at a temperature of from about −10° C. to about 30° C.

In some embodiments, the HCFO-1242zf and HF portion of an azeotropic or near azeotropic composition of HCFO-1242zf, HFO-1243zf, and HF includes about 38.0 mol % HCFO-1242zf and about 62.0 mol % HF with a vapor pressure of about 25.9 psia at a temperature of about 20° C.

In some embodiments, the first and second distillation column operate at from about 14.7 psia (101 kPa) to about 300 psia (2068 kPa), with a top temperature of from about −50° C. to about 200° C. and a bottom temperature from about −30° C. to about 220° C. In another embodiment, the pressure will range from about 50 psia (345 kPa) to about 250 psia (1724 kPa), with a top temperature of from about −25° C. to about 100° C. and a bottom temperature from about 0° C. to about 150° C.

In separation processes described herein that include more than one distillation column, the distillation columns may all operate at the same pressure and/or temperature or at different pressures and/or temperatures.

Where the composition to be separated is a reaction product stream formed by fluorination of HCC-250fb with HF, it is desirable to recycle any unreacted HCFO-1242zf back to the reactor so that it may be converted to HFO-1243zf. However, it is necessary that HFO-1243zf be removed from the unreacted HCFO-1242zf prior to being recycled so as not to inhibit the equilibrium reaction. It is also necessary that the HF be removed from the HFO-1243zf and HCFO-1242zf to allow its use as a reagent in the fluorination reaction or another reaction or as a refrigerant or in other applications.

### Other Embodiments

Forming a first distillate stream comprising HFO-1243zf, HCFO-1242zf and a molar excess of HF.

Forming a first distillate stream comprising HFO-1243zf, HCFO-1242zf and sufficient HF to form azeotrope or near azeotropes of HCFO-1242zf/HF and HFO-1243zf/HF.

Condensing the first distillate HFO-1243zf, HCFO-1242zf and sufficient HF to form azeotrope or near azeotropes of HCFO-1242zf/HF and HFO-1243zf/HF.

Recovering azeotrope or near azeotropes of at least one of HCFO-1242zf/HF and HFO-1243zf/HF

### Producing Heterogenous Azeotropes.

Producing heterogenous azeotropes of HFO-1243zf/HF and HFO-1242zf/HF.

Condensing and decanting the first distillate comprising HFO-1243zf, HCFO-1242zf and sufficient HF and recovering HCFO-1242zf/HF and HFO-1243zf/HF azeotrope or near azeotropes.

Forming an HFO-1242zf enriched phase and HCFO-1242zf poor phase and recycling the HFO-1242zf enriched phase.

Forming and recycling an HF enriched phase comprising HFO-1242zf/HF to the first distillation column.

Operating a distillation column at pressures greater than about 14.7 psig, preferably at between about 14.7 psig and about 500 psig, more preferably between about 30 psig and about 150 psig to form a first distillate comprising HFO-1243zf, HCFO-1242zf and sufficient HF.

Operating a second distillation wherein an HCFO-1242zf-rich stream under the boiling conditions of HCFO-1242zf and HFO-1243z azeotropes and forming a second distillate stream comprising an azeotropic or near-azeotropic composition of HCFO-1242zf, HFO-1243zf, and HF and a second bottoms stream of −1242zf and HFO-1243zf essentially free of HF from the second distillation column.

Subjecting a second bottoms stream of HCFO-1242zf and HFO-1243zf essentially free of HF to distillation in a third distillation column to form an HCFO-1242zf stream essentially free of HFO-1243zf.

Process of combining a first distillate stream of HFO-1243zf, HCFO-1242zf and sufficient HF to form heterogenous azeotropes with a second distillate stream comprising azeotropic or near-azeotropic compositions of HCFO-1242zf, HFO-1243zf, and HF and forming heterogenous azeotrope or near-azeotropes upon condensation.

Forming a first distillate stream and a second distillate stream comprising about 9.8 to about 70.6 mole percent HCFO-1242zf and from about 90.2 to about 29.4 mole percent HF and having a vapor pressure of from about 6.5 psia (44.8 kPa) to about 29.8 psia (205.5 kPa) at a temperature of from about −10° C. to about 30° C.

Forming a first distillate stream and said second distillate stream comprising about 38.0 mol % HCFO-1242zf and about 62.0 mol % HF at a temperature of about 20° C. and a vapor pressure of about 25.9 psia.

Separating 3-chloro-3,3-difluoro-1-propene (HCFO-1242zf) from an HCFO-1242zf-rich stream comprising HCFO-1242zf, 3,3,3-trifluoropropene (HFO-1243zf), and hydrogen fluoride (HF).

Forming, obtaining, recovering a first distillate stream comprising about 9.8 to about 70.6 mole percent HCFO-1242zf and from about 90.2 to about 29.4 mole percent HF at a vapor pressure of from about 6.5 psia to about 29.8 psia at a temperature of from about −10° C. to about 30° C.

Forming, obtaining, recovering a first distillate stream comprising about 38.0 mol % HCFO-1242zf and about 62.0 mol % HF at a temperature of about 20° C. and a vapor pressure of about 25.9 psia.

Obtaining an azeotropic or near-azeotropic composition comprising 3-chloro-3,3-difluoro-1-propene (HCFO-1242zf), 3,3,3-trifluoropropene (HFO-1243zf), and hydrogen fluoride (HF) comprising, consisting essentially of, or consisting of about 9.8 to about 70.6 mole percent HCFO-1242zf and from about 90.2 to about 29.4 mole percent HF at a vapor pressure of from about 6.5 psia to about 29.8 psia at a temperature of from about −10° C. to about 30° C.

Obtaining an azeotropic or near-azeotropic composition comprising 3-chloro-3,3-difluoro-1-propene (HCFO-1242zf), 3,3,3-trifluoropropene (HFO-1243zf), and hydrogen fluoride (HF) comprising, consisting essentially of, or consisting of about 38.0 mol % HCFO-1242zf and about 62.0 mol % HF at a temperature of about 20° C. and vapor pressure of about 25.9 psia.

It will be understood by those skilled in the art that any of the foregoing embodiments may be combined with each other in any manner.

In the foregoing specification, the concepts have been described with reference to specific embodiments. However, one of ordinary skill in the art appreciates that various modifications and changes can be made without departing from the scope of the invention as set forth in the claims below. However, the benefits, advantages, solutions to problems, and any feature(s) that may cause any benefit, advantage, or solution to occur or become more pronounced are not to be construed as a critical, required, or essential feature of any or all the claims.

Accordingly, the specification and figures are to be regarded in an illustrative rather than a restrictive sense, and all such modifications are intended to be included within the scope of invention. Note that not all of the activities described above in the general description, or the examples are required, that a portion of a specific activity may not be required, and that one or more further activities may be performed in addition to those described. Still further, the order in which activities are listed are not necessarily the order in which they are performed.

It is to be appreciated that certain features are, for clarity, described herein in the context of separate embodiments, may also be provided in combination in a single embodiment. Conversely, various features that are, for brevity, described in the context of a single embodiment, may also be provided separately or in any sub combination. Further, references to values stated in ranges include each and every value within that range.

Many aspects and embodiments have been described above and are merely exemplary and not limiting. After reading this specification, skilled artisans appreciate that other aspects and embodiments are possible without departing from the scope of the invention.

1. An azeotropic or near-azeotropic composition comprising 3-chloro-3,3-difluoro-1-propene (HCFO-1242zf) and hydrogen fluoride (HF).

2. The azeotropic or near-azeotropic composition of claim 1, wherein said azeotropic or near-azeotropic composition comprises about 9.8 to about 70.6 mole percent HCFO-1242zf and from about 90.2 to about 29.4 mole percent HF.

3. The azeotropic or near-azeotropic composition of claim 1, wherein the azeotropic or near-azeotropic composition has a vapor pressure of from about 6.5 psia (44.8 kPa) to about 29.8 psia (205.5 kPa) at a temperature of from about −10° C. to about 30° C.

4. The azeotropic or near-azeotropic composition of claim 1, wherein said azeotropic or near-azeotropic composition comprises about 38.0 mol % HCFO-1242zf and about 62.0 mol % HF.

5. The azeotropic or near-azeotropic composition of claim 1, wherein the azeotropic or near-azeotropic composition has a vapor pressure of about 25.9 psia at a temperature of about 20° C.

6. The azeotropic or near-azeotropic composition of claim 1, wherein the azeotropic or near-azeotropic composition is prepared by weighing desired amounts of HCFO-1242zf and HF and thereafter combining them in an appropriate container.

7. The azeotropic or near-azeotropic composition of claim 1, wherein the azeotropic or near-azeotropic composition consists essentially of HCFO-1242zf and HF.

8. A composition comprising the azeotropic or near-azeotropic composition of claim 1 and 3,3,3-trifluoropropene (HFO-1243zf).

9. A composition comprising the azeotropic or near-azeotropic composition of claim 1 and 1,1,1,3-tetrafluoropropane (HFC-254fb).

10. The composition of claim 1, wherein the composition further comprises one or more additional components selected from the group consisting of 3-chloro-3,3,-difluoropropene (HCFO-1242zf; CF₂Cl—CH═CH₂), dichlorodifluoromethane (CFC-12; CCl₂F₂), chlorotrifluoromethane (CFC-13; CCIF₃), 1,1,1-trifluoroethane (HFC-143a; CF₃—CH₃), 2-chloro-1,1,1-trifluoropropane (HCFC-253 db; CF₃—CHCl—CH₃), 3-chloro-1,1,1-trifluoropropane (HCFC-253fb; CF₃—CH₂—CH₂Cl), 1,1,1,2-tetrafluoropropane (HFC-254eb; CF₃—CHF—CH₃), 1,1,1-trifluoropropane (HFC-263fb; CF₃CH₂CH₃), 2-chloro-3,3,3-trifluoropropene (HCFO-1233xf; CF₃—CCl═CH₂), 1-chloro-3,3,3-trifluoropropene (HCFO-1233zd; CF₃—CH₂═CHCl), isomers of trichloropropene (HCO-1240; C₃H₃Cl₃), and combinations thereof.

11. An azeotropic or near-azeotropic composition comprising 3-chloro-3,3-difluoro-1-propene (HCFO-1242zf), 3,3,3-trifluoropropene (HFO-1243zf), and hydrogen fluoride (HF).

12. A composition comprising a mixture of an azeotrope or near-azeotrope comprising 3-chloro-3,3-difluoro-1-propene (HCFO-1242zf) and hydrogen fluoride (HF) and an azeotrope or near-azeotrope comprising 3,3,3-trifluoropropene (HFO-1243zf) and HF.

13. The composition of claim 11, wherein an HCFO-1242zf and HF portion of the azeotropic or near azeotropic composition comprises about 9.8 to about 70.6 mole percent HCFO-1242zf and about 90.2 to about 29.4 mole percent HF.

14. The composition of claim 11, wherein an HCFO-1242zf and HF portion of the azeotropic or near azeotropic composition has a vapor pressure of from about 6.5 psia (44.8 kPa) to about 29.8 psia (205.5 kPa) at a temperature of from about −10° C. to about 30° C.

15. The composition of claim 11, wherein an HCFO-1242zf and HF portion of the azeotropic or near azeotropic composition comprises about 38.0 mol % HCFO-1242zf and about 62.0 mol % HF.

16. The composition of claim 11, wherein an HCFO-1242zf and HF portion of the azeotropic or near azeotropic composition has a vapor pressure of about 25.9 psia at a temperature of about 20° C.

17. The composition of claim 11, further comprising 1,1,1,3-tetrafluoropropane (HFC-254fb).

18. The composition of claim 12, wherein the HCFO-1242zf and HF portion of the azeotropic or near azeotropic composition comprises about 9.8 to about 70.6 mole percent HCFO-1242zf and about 90.2 to about 29.4 mole percent HF.

19. The composition of claim 12, wherein the HCFO-1242zf and HF portion of the azeotropic or near azeotropic composition has a vapor pressure of from about 6.5 psia (44.8 kPa) to about 29.8 psia (205.5 kPa) at a temperature of from about −10° C. to about 30° C.

20. The composition of claim 12, wherein the HCFO-1242zf and HF portion of the azeotropic or near azeotropic composition comprises about 38.0 mol % HCFO-1242zf and about 62.0 mol % HF.

21. The composition of claim 12, wherein the HCFO-1242zf and HF portion of the azeotropic or near azeotropic composition has a vapor pressure of about 25.9 psia at a temperature of about 20° C.

22. The composition of claim 12, further comprising 1,1,1,3-tetrafluoropropane (HFC-254fb).
